(19) United States
(12) Patent Application Publication
(10) Pub. No.: US 2005/0187812 A1
(43) Pub. Date: Aug. 25, 2005

(54) Method, system, and storage medium for predicting passenger flow at a transportation facility

(75) Inventors: Richard Boedi, Adliswil (CH); Markus Kunz, Buchs (CH)

Correspondence Address: Rafael Perez-Pineiro;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 10/786,637

(22) Filed: Feb. 25, 2004

(51) Int. Cl. G06F 17/60

(52) U.S. Cl. 705/10

(57) ABSTRACT

Exemplary embodiments of the invention relate to a method, system, and storage medium for predicting passenger flow at a transportation facility. The method includes includes receiving passenger reservation data from a global distribution system. The method also includes receiving transportation facility-specific data, parsing the passenger reservation data and the transportation facility-specific data, and storing the results in a data repository. In response to a request for passenger flow information from a requester, the method further includes extracting selected data from the data repository according to the request, performing an analysis on the selected data, and making the results of the analysis on accessible for access by the requester.

### BACKGROUND OF THE INVENTION

The present invention relates generally to passenger flow management, and more particularly, to a method, system, and storage medium for predicting passenger flow at a transportation facility.

Airports and other mass transportation facilities have limited information regarding anticipated passenger flows for future time periods. Knowledge about passenger flows is mainly based upon historical experience or inquiries, surveys, and census information, which are expensive to conduct and typically represent only a snapshot of the overall picture. Operations personnel, facility retailers, maintenance, and other related groups are affected by this lack of information as well in terms of staffing, logistics, marketing, etc. Passengers themselves, who find themselves queued in front of check-in counters, ticketing counters, passport, security, retail, and other facility locations for extended time periods, are clearly affected by the lack of passenger flow information available to the transportation facility.

Existing solutions offer some passenger flow information using only historical flow data to predict future flow behaviors. These solutions, however, are known to be inaccurate and imprecise. What is needed, therefore, is a way to better predict passenger flows at a transportation facility.

### BRIEF SUMMARY OF THE INVENTION

Exemplary embodiments of the invention relate to a method, system, and storage medium for predicting passenger flow at a transportation facility. The method includes receiving passenger reservation data from a global distribution system. The method also includes receiving transportation facility-specific data, parsing the passenger reservation data, transportation facility-specific data, and storing the results in a data repository. In response to a request for passenger flow information from a requester, the method further includes extracting selected data from the data repository according to the request, performing an analysis on the selected data, and making the results of the analysis accessible to the requester.

### BRIEF DESCRIPTION OF THE DRAWINGS

The invention will be more fully understood in light of the following detailed description of taken together with the following drawings, which are illustrative, rather than limiting:

FIG. 1 is a block diagram illustrating a system within which the passenger flow system may be implemented in exemplary embodiments;

FIG. 2 is a flowchart describing a process for implementing the passenger flow system in exemplary embodiments;

FIG. 3A is a sample departure flight table received from a global distribution system and utilized by the passenger flow system in exemplary embodiments;

FIG. 3B is a sample departure passenger table received from a global distribution system and utilized by the passenger flow system in exemplary embodiments;

FIG. 4A is a sample arrival flight table received from a global distribution system and utilized by the passenger flow system in exemplary embodiments;

FIG. 4B is a sample arrival passenger table received from a global distribution system and utilized by the passenger flow system in exemplary embodiments;

FIG. 5A is a sample gate allocation arrival table for a specific airport that is utilized by the passenger flow system in exemplary embodiments;

FIG. 5B is a sample gate allocation departure table for a specific airport that is utilized by the passenger flow system in exemplary embodiments;

FIG. 6A is a sample real passenger arrival table for a specific airport that is utilized by the passenger flow system in exemplary embodiments;

FIG. 6B is a sample real passenger departure table for a specific airport that is utilized by the passenger flow system in exemplary embodiments;

FIG. 7A is a sample arrival interval table for a specific airport that is utilized by the passenger flow system in exemplary embodiments;

FIG. 7B is a sample departure interval table for a specific airport that is utilized by the passenger flow system in exemplary embodiments;

FIG. 8 is a sample user interface as seen by an authorized user of the passenger flow system in exemplary embodiments; and

FIG. 9 is a sample graph produced by the passenger flow system in response to a request by an authorized passenger flow system user for passenger flow information in exemplary embodiments.

### DETAILED DESCRIPTION OF PREFERRED EMBODIMENTS OF THE INVENTION

The passenger flow system is a forecasting tool that may be used to optimize resources associated with a transportation facility for end-to-end activities including passenger check-in to boarding or arrival by plane to leaving the airport. The passenger flow system can predict passenger flows for the facility for up to seven days in the future, allowing the facility's operations and related organizations an opportunity to generate more revenue in retail, catering, and value-added services.

The passenger flow system is customizable to accommodate the needs of any transportation facility. The transportation facility's physical layout and operational groups are organized into zones. Passenger reservation data and historical data are used to identify which zones and related operational groups will be affected and how they will be affected. Information such as passenger volumes and volume distribution by zone, peak volume times, allow facility operations personnel to better plan for staffing, equipment and grounds maintenance schedules, targeted marketing and sales campaigns, and other items.

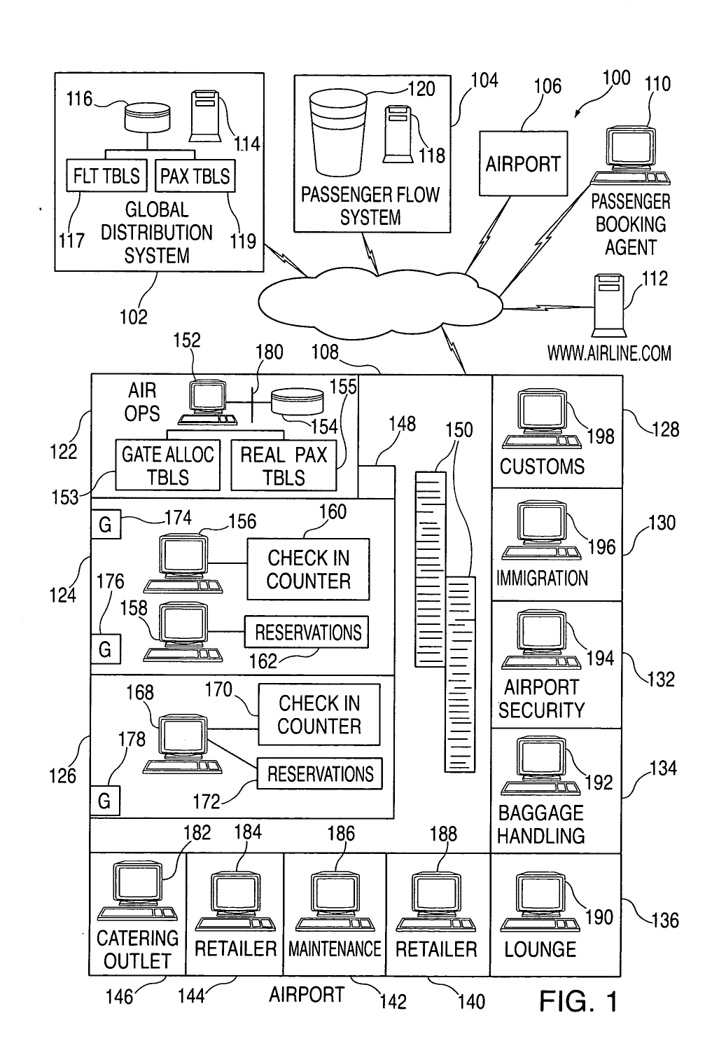

The passenger flow system may be implemented over a system such as that depicted in FIG. 1. While the system of FIG. 1 relates to air transportation facilities, it will be understood that the passenger flow system is equally applicable to any mass transportation system such as railroad, bus lines, subways, etc. System 100 includes a global distribution system 102, a passenger flow system 104, airports 106 and 108, a passenger booking agent system 110, and a server 112, each of which are in communication via a network such as an Intranet, Extranet, Internet, or other similar suitable networking infrastructure.

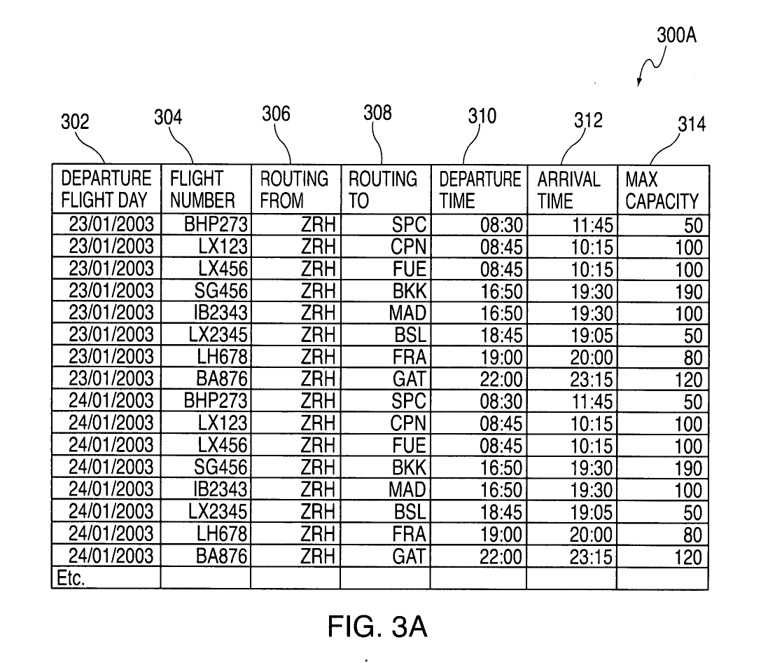

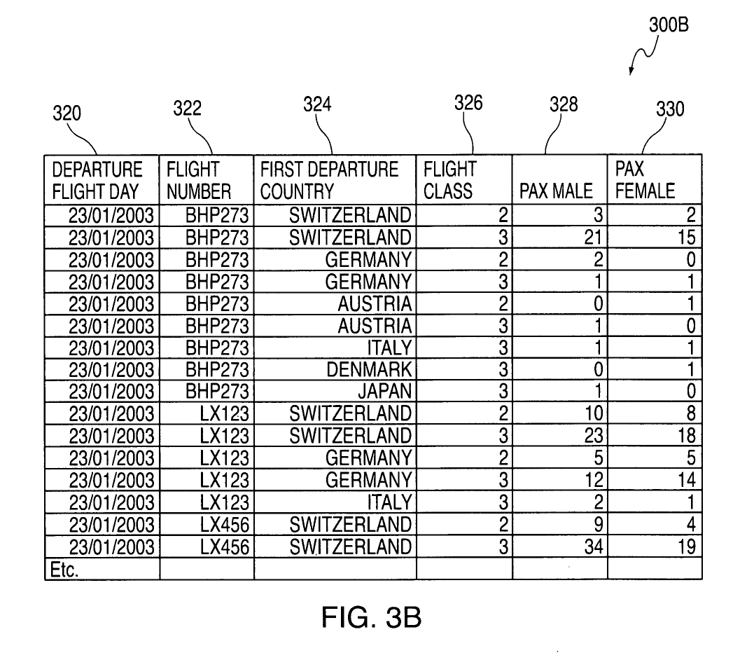

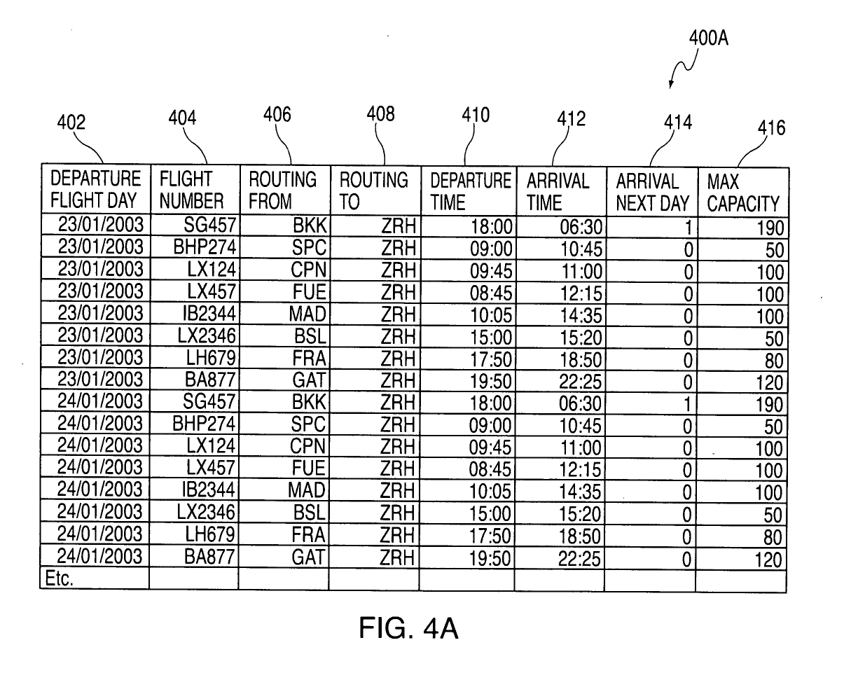

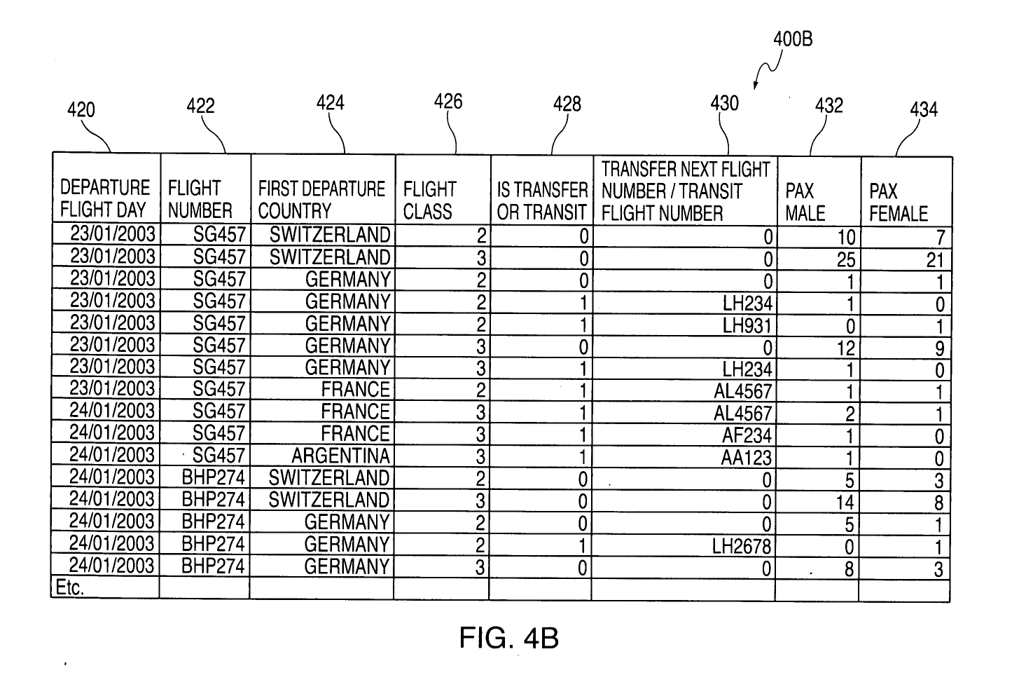

Global distribution system 102 refers to a reservation engine that handles passenger bookings made by travel agents and directly by airlines and provides shared access to flight reservations for a variety of airlines. For example, global distribution system 102 may be the European airlines reservation system, Amadeus™. The Amadeus™ system comprises a massive interactive database that handles and updates requests for travel between travel agencies and airlines. Global distribution system 102 comprises a server 114 and data repository 116. Typical flight information stored in data repository 116 includes airline, flight number, arrival and departure times and locations, aircraft capacities, airport, and flight class. Additionally, personal information about passengers may also be stored in data repository 116 such as passenger name, address, gender, date of birth, and financial account information used to purchase the ticket. Much of this personal information is confidential (e.g., name, address, and financial account information). Further, due to the proliferation of electronic data exchange, other information that may be stored in data repository 116 includes car rental information, hotel reservation information, travel itineraries, and similar data. Global distribution system 102 stores tables of data such as flight tables 117 and passenger tables 119. These tables are, in turn, provided to passenger flow system 104 for implementing the invention as described further herein. Additionally, flight tables 117 correspond to FIGS. 3A and 4A and passenger tables 119 correspond to FIGS. 3B and 4B.

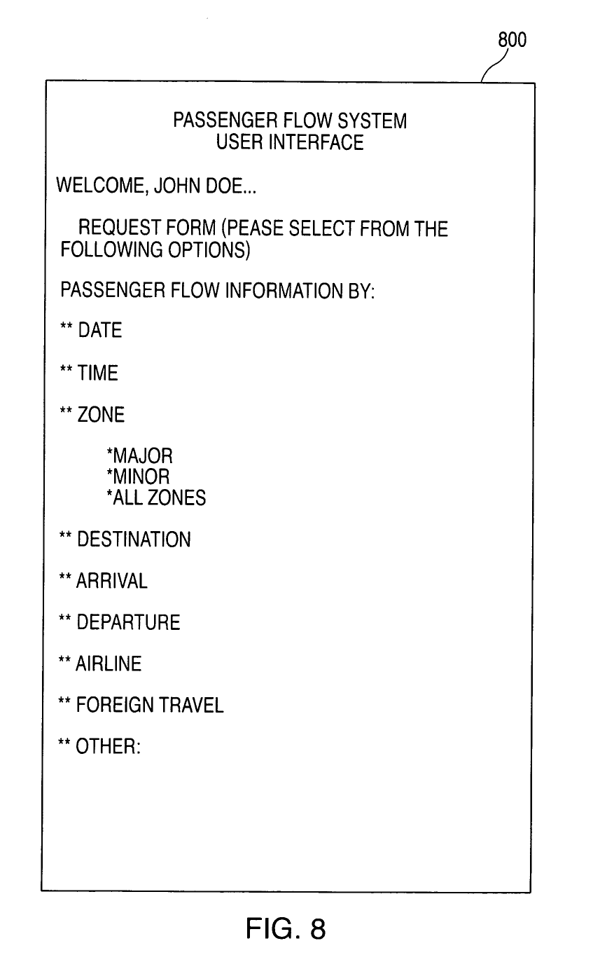

Passenger flow system 104 hosts the services offered via the invention. Passenger flow system 104 includes a host system 118 and data repository 120. Host system 118 comprises a high-powered computer processor such as IBM's® eServer zSeries™ processor for handling the large volume of transportation and passenger data as described further herein. Host system 118 executes a variety of software applications such as a web server, an optional billing application, an analysis engine, and a graphics tool. Host system 118 also includes a passenger flow system user interface (see generally FIG. 8) for allowing third parties to access information stored in data repository 120. Data repositories 116 and 120 are logically addressable to servers 114 and 118, respectively.

While systems 102 and 104 each illustrate a server and data repository, it will be understood by those skilled in the art that a single computer system may be employed by each system such as a mainframe computer.

Airports 106 and 108 refer to transportation facilities utilizing the passenger flow system of the invention. In exemplary embodiments, passenger flow system 104 provides services to airports 106 and 108, typically under a subscription agreement or contract. It will be understood that any number of airports and/or other transportation facilities may be serviced by passenger flow system 104.

Passenger booking agent system 110 refers to a travel agency or non-airline entity that provides reservations and travel services to passengers. Passenger booking agent system 110 includes a web-enabled computer with Internet service for accessing global distribution system 102 on behalf of its customers. The computer of passenger booking agent system 110 may comprise a desktop, laptop, or similar computing device.

Server 112 refers to an online reservation service system directed to a specific airline. A passenger who wishes to purchase tickets online accesses server 112 via the airline's website. Server 112, in turn, accesses global distribution system 102 for available flight and seating information.

Airports 106 and 108 are organized by the passenger flow system into major zones. For illustrative purposes, only airport 108 depicts these major zones, namely 122-146. Zones refer to physical locations and/or operational groups associated with airports 106 and 108. Zones are used to identify and provide notification of passenger flows to affected areas of airports 106 and 108 over a given time period. Major zones include airline-specific locations, airline operations, customs, baggage, retail establishments, and similar entities. Major zones shown in airport 108 include zones 122-136 and 140-146.

Minor zones include specific locations within a zone and miscellaneous locations not provided above. Minor zones include 148, 150, 156-162, and 168-178.

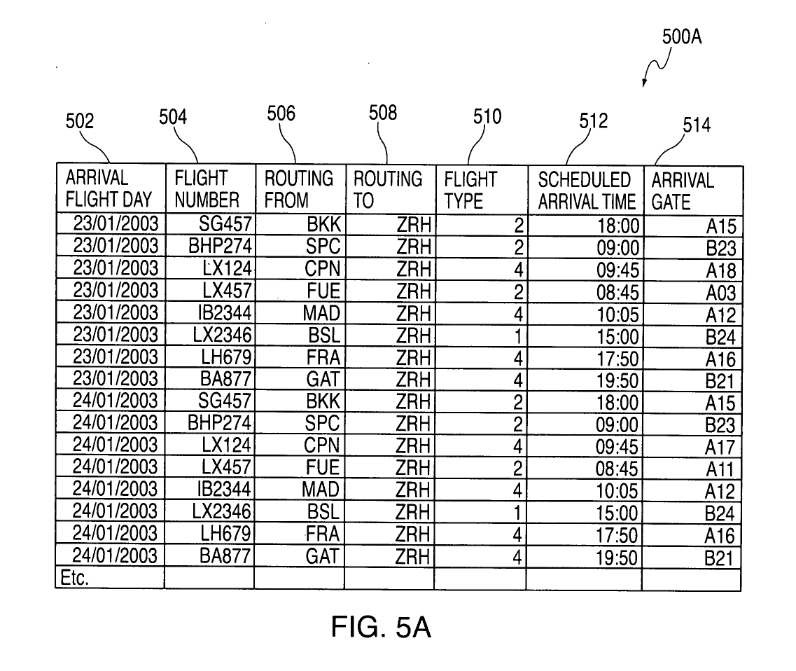

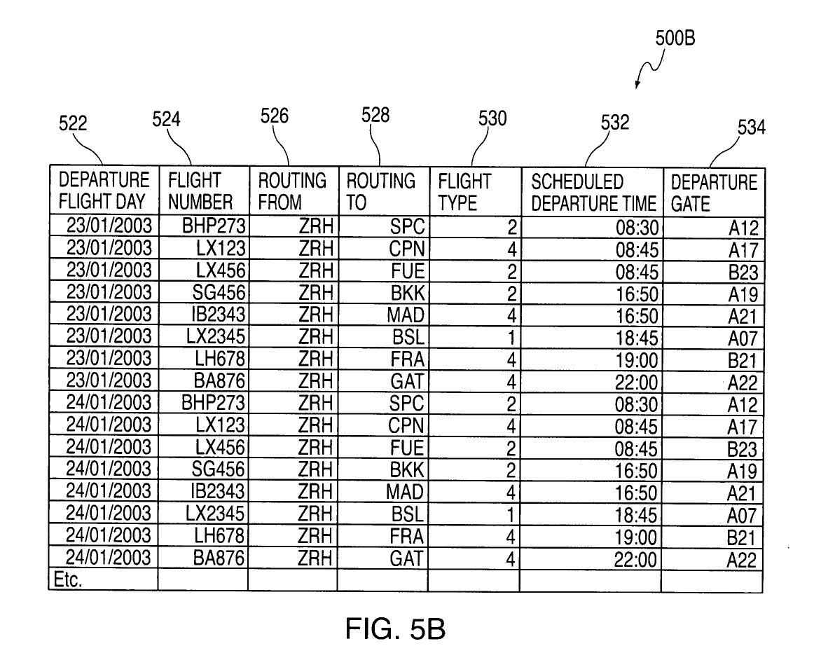

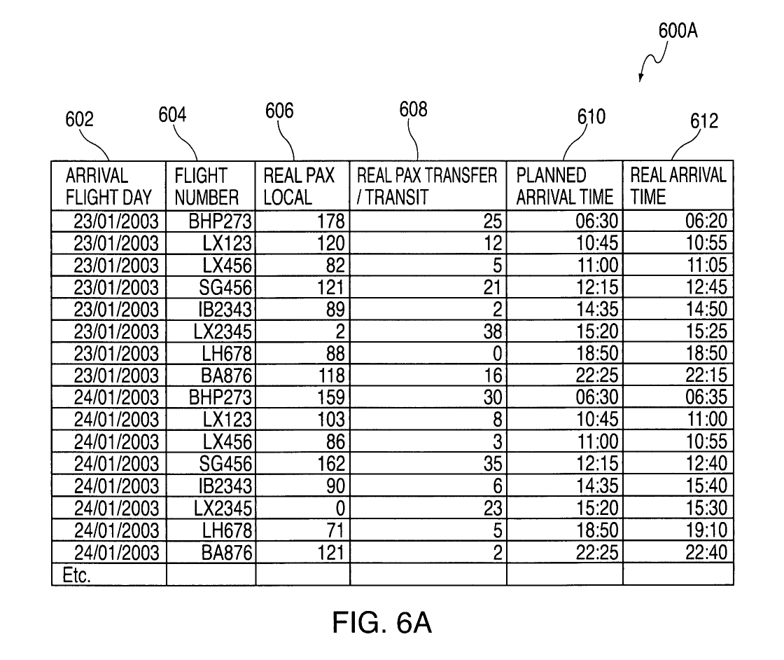

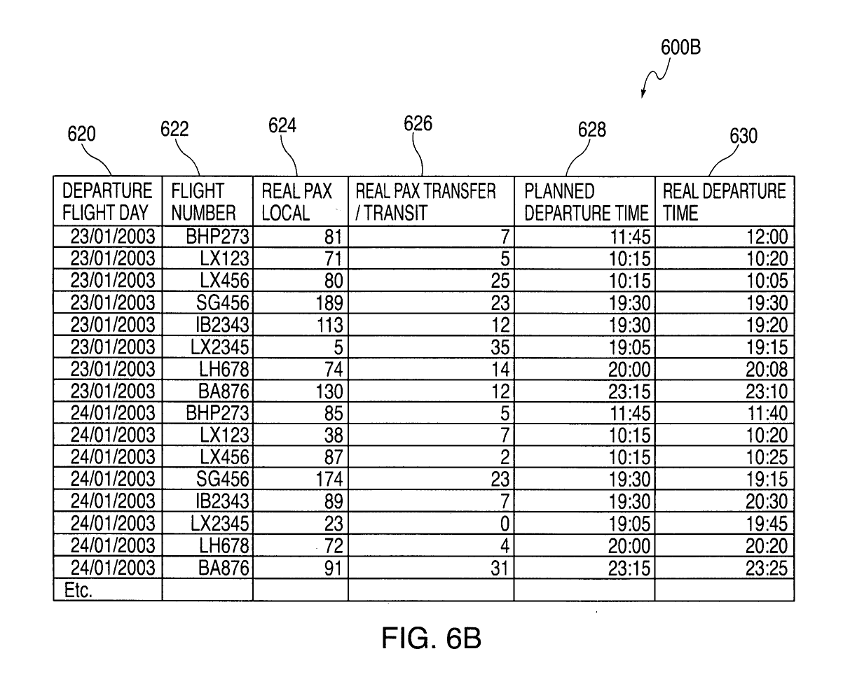

Each major zone will now be described. Zone 122 refers to airport operations. Airport operations are the nerve center of the airport, managing the collective activities conducted within airport 108 such as airline liaison functions, grounds maintenance, retail management, airport security, etc. Zone 122 includes a computer system 152 and data repository 154 in communication with other zones within airport 108 via a network 180. Network 180 may be an Intranet or similar type of network. Data repository 154 (also referred to herein as airport operations database) stores airport operations data in accordance with the needs of the airport organization. For example, data repository 154 stores future-oriented tables (e.g., gate allocation tables 153) and history-oriented tables (e.g., real passenger tables 155). Gate allocation tables 153 provide future-oriented information for use in predicting anticipated passenger flows for a future time period. Real passenger tables 155 provide history-oriented data that is used for statistical purposes (e.g., actual passenger numbers per flight, actual departure/arrival times, etc.). Gate allocation tables 153 correspond to FIGS. 5A and 5B. Real passenger tables 155 correspond to FIGS. 6A and 6B.

Zones 124 and 126 refer to airline entities. For example, zone 124 may be operated by Delta Airlines® and zone 124 may be operated by USAir®. Zone 124 includes computer systems 156 and 158 coupled to check in counter 160 and reservations counter 162, respectively. Zone 124 further includes two boarding gates 174 and 176.

Zone 126 includes a computer system 168 coupled to check in counter 170 and reservations counter 172. Zone 126 further includes one boarding gate 178.

Zones 128-146 represent various airport entities. Zone 128 represents Customs, zone 130 represents Immigration, zone 132 refers to airport security, and zone 134 refers to baggage handling. Each of zones 128-134 includes computer systems 192-198, respectively.

Zone 136 refers to a passenger lounge, and zones 140 and 144 refer to retail establishments, such as a bookstore, souvenir shop, or duty-free shop. Zone 142 refers to airport maintenance (e.g., janitorial services, grounds keeping, and building repairs), and zone 146 refers to a catering outlet. Zones 136 and 140-146 each include computer systems 190-182, respectively.

Each of major zones 122-136 and 140-146 are in communication with passenger flow system 104 via the passenger flow system user interface.

As indicated above, minor zones include 148, 150, 156-162, and 168-178. Each minor zone will now be described. Zone 148 refers to a handicap-accessible elevator and zone 150 refers to an escalator. Zones 156 and 160, zones 158 and 162, zones 168 and 170-172 represent service entities of a specific airline. For example, using the example above, zones 156 and 160 represent a computer system and check in counter operated by a staff member of Delta Airlines®. Because these zones fall within major zones 124 and 126, they are deemed to be minor zones. Minor zones that are equipped with computer systems may be in communication with any of major zones 122-136 and 140-146, as well as with passenger flow system 104 on an access permission basis.

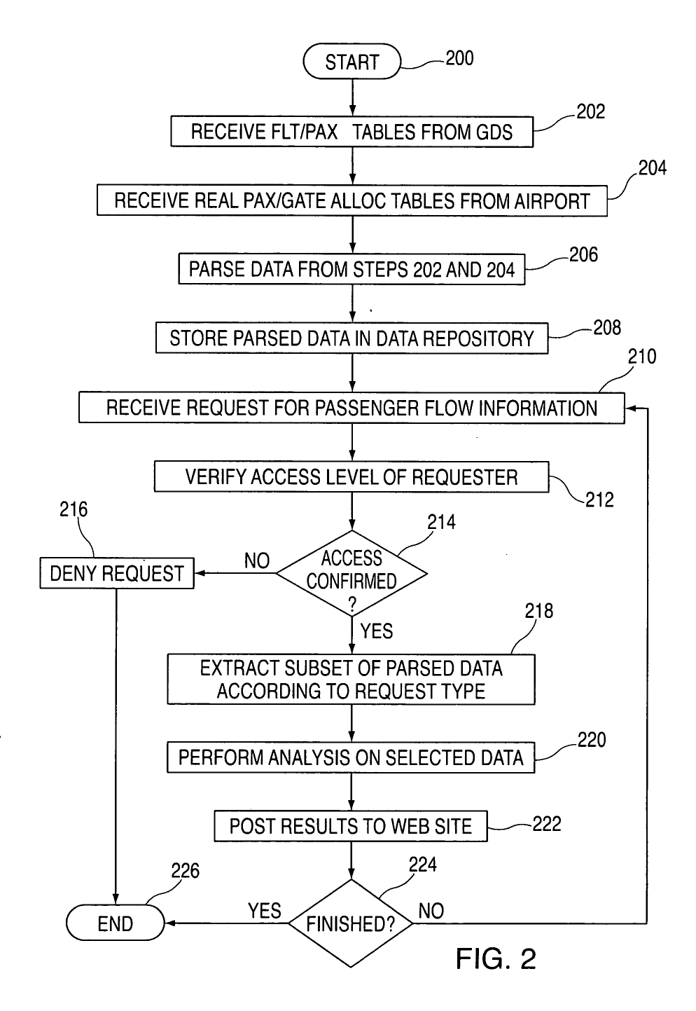

Operation of the passenger flow system of the invention will now be described with reference to FIG. 2. The process begins at step 200 whereby host system 118 receives passenger reservation data from global distribution system (GDS) 102 at step 202. Such passenger reservation data may for example include per flight number of reservations for each combination of flight class, gender, booking country, and connecting flight information. Because of the sensitivity of passenger information, strict security systems are implemented by passenger flow system 104 in obtaining and handling the passenger information. Firewall software and encryption tools may be utilized for this purpose. Sample tables 300A, 300B, 400A, and 400B received from GDS 102 are illustrated in FIGS. 3 and 4.

FIG. 3A represents a departure flight table 300A that includes data fields 302-314 for specifying travel details by flight number 304 and departure date 302. Routing from field 306 and routing to field 308 specify the departure location and destination for each flight, respectively. Departure time field 310 and arrival time field 312 indicate the times that a flight is scheduled to leave the airport and arrive at its destination, respectively. Maximum capacity field 314 indicates the maximum number of occupants available per flight.

FIG. 3B refers to a sample departure passenger table 300B received from global distribution system 102. In addition to providing departure day field 320 and flight number field 322 similar to that described in FIG. 3A, table 300B also specifies the country of first departure for the flight in field 324 (i.e., booking country), the flight class (e.g., first, second, and economy class in field 326), and number of male passengers (field 328) and female passengers (field 330) on the flight (both of fields 328 and 330 referring to the first departure country item 324).

FIG. 4A is a sample arrival flight table 400A received from global distribution system 102. Table 400A includes similar information as described above with respect to FIG. 3A (except that table 400A refers to arrivals rather than departures), but includes an additional field, “arrival next day” 414 indicating whether the arrival is on the same day as the flight date of field 402 or whether the arrival is on a different date. This field 414 is formatted to receive data in integer form (e.g., ‘0’ indicating that the arrival date is the same as the flight date, ‘1’ indicating that the arrival date is the date following the flight date, etc.).

FIG. 4B is a sample arrival passenger table 400B received from global distribution system 102. Table 400B includes fields similar to those described above in FIG. 3B (except that table 400B refers to arrivals rather than departures) but also includes connecting flight information such as transfer/transit field 428 and transfer/transit next flight number field 430. Transfer/transit field 428 indicates the number of passengers on a flight that are local to the flight (e.g., represented by a ‘0’ in field 428), the number of passengers on the flight that are in transfer status (e.g., represented by a ‘1’ in field 428) and those passengers who are in transit (e.g., represented by a ‘2’ in field 428).

Referring back to FIG. 2, at step 204, host system 118 receives airport-specific data (e.g., gate allocation tables 153, real passenger tables 155) from airport 108. Airport-specific data may include past passenger volumes and predicted volumes based upon past activities. Gate allocation tables 153 are illustrated in FIGS. 5A and 5B. Table 500A of FIG. 5 represents a gate allocation arrival table and includes arrival flight day field 502, flight number field 504, and routing from/to fields 506 and 508, respectively. Table 500A further includes a flight type field 510 that represents whether a flight is domestic or international, scheduled arrival time field 512 representing the planned arrival time for the flight, and arrival gate field 514 representing the gate identifier for the flight.

Table 500B of FIG. 5B refers to a gate allocation departure table. Table 500B includes fields similar to those described in FIG. 5A but includes a scheduled departure time field 532 and departure gate field 534 in lieu of fields 512 and 514.

Other airport-specific data include real passenger information. FIG. 6A illustrates a sample real passenger arrival table 600A that includes arrival flight day field 602, flight number field 604, actual passenger local field 606, actual passenger transfer/transit field 608, planned arrival time field 610, and actual arrival time field 612. Actual passenger local field 606 reflects the actual number of local passengers aboard the flight. Actual passenger transfer/transit field 608 specifies the actual number of transfer/transit passengers that were on the flight. Planned arrival time field 610 refers to time that the flight was scheduled to arrive. Actual arrival time field 612 indicates the actual time that the aircraft arrived at the airport. The airport operations group (e.g., zone 122) performs continuous checks in AODB 154 to gather updated information regarding actual passenger numbers, flight classes, gender data, etc.

FIG. 6B includes a real passenger departure table 600B that is similar to table 600A except that it provides departure information rather than arrival information. Fields 620-630 include flight and departure information accordingly.

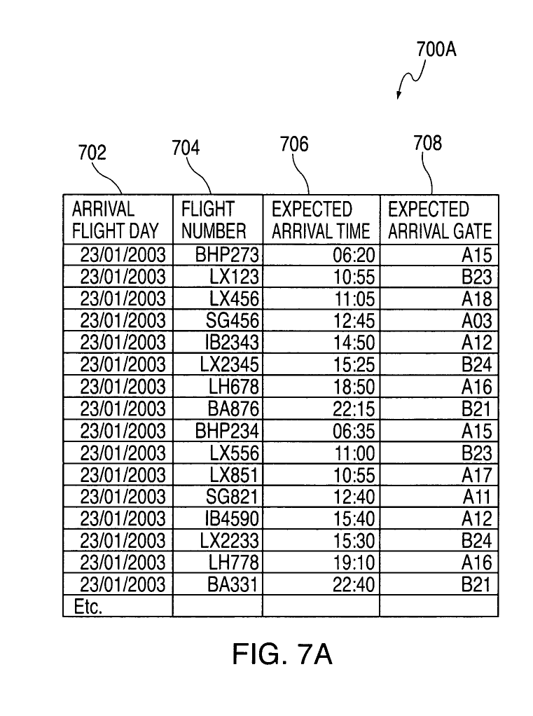

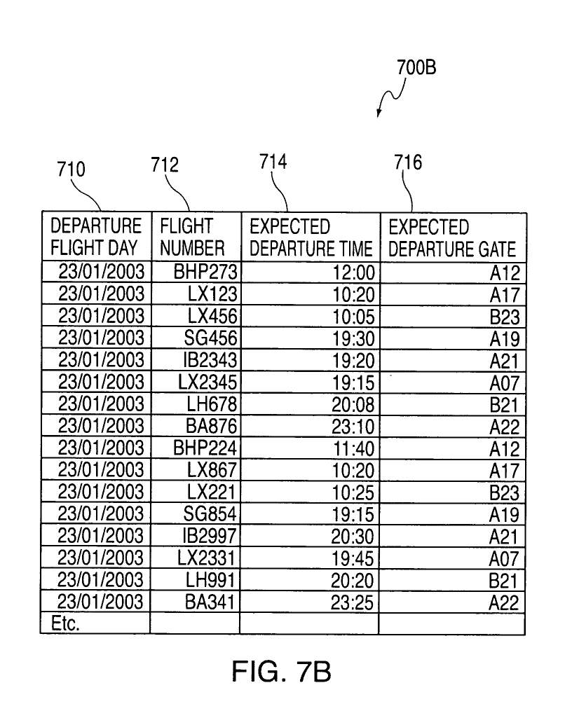

In alternative embodiments, a transportation facility such as airport 108 may wish to gather more timely flight data in order to provide collateral or value-added services to its constituents. For example, airport 108 may provide ground transportation for travelers leaving airport 108 or for shuttling passengers between airport terminals. Given the frequent occurrence of flight delays/cancellations due to weather conditions, mechanical failures, etc., it is important to have access to the most current flight information at all times in order to coordinate these ground transportation activities. The arrival interval table 700A (FIG. 7A) and departure interval table 700B (FIG. 7B) are utilized by the passenger flow system for this purpose. Arrival interval table 700A includes arrival flight day field 702, flight number field 704, expected arrival time field 706, and expected arrival gate field 708. Expected arrival time field 706 refers to the arrival time that is calculated using the actual (not scheduled) departure time for the flight's departure location. Expected arrival gate field 708 refers to the current arrival gate scheduled for this flight.

Departure interval table 700B of FIG. 7B includes departure flight day field 710, flight number field 712, expected departure time field 714, and expected departure gate field 716. Expected departure time field 714 refers to the departure time that is calculated taking into consideration any delays for the aircraft that have occurred on earlier flight(s).

The passenger flow system continuously updates this information in order to provide the most up-to-date passenger and flight data that can be used by ground transportation entities.

Referring back to FIG. 2, the data received from steps 202 and 204 are parsed at step 206 in order to collect and classify the information from the two sources. Once parsed, the data is stored in data repository 120 at step 208.

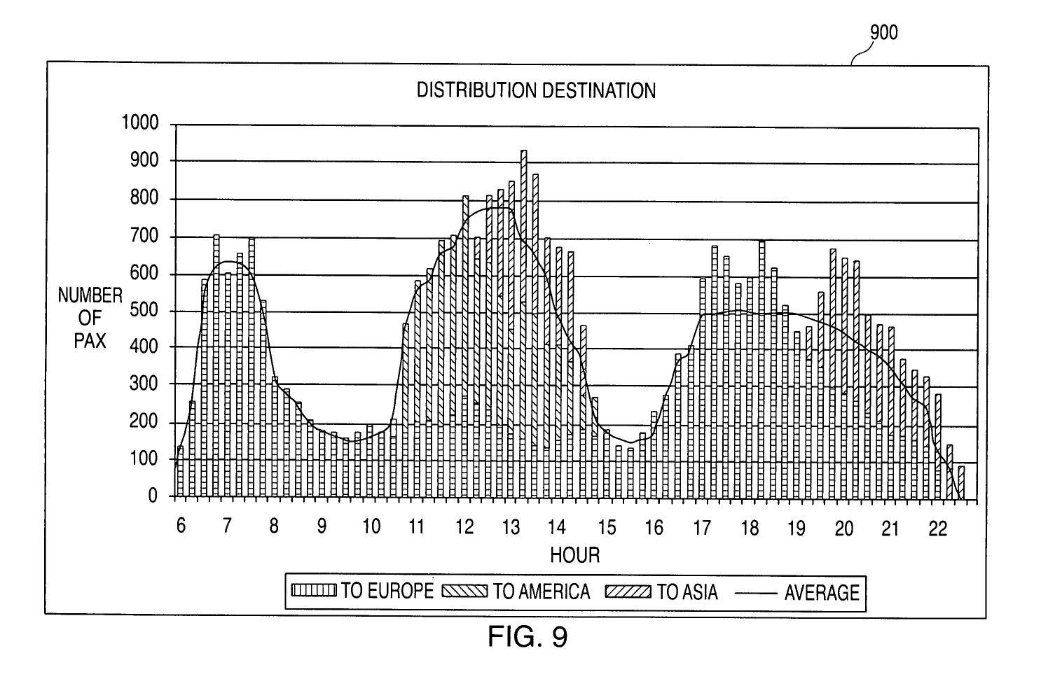

At step 210, host system 118 receives a request for passenger flow information via the passenger flow user interface over the Web from one of the major or minor zones described in airport 108. For example, the customs group of zone 128 may initiate the request via web-enabled computer system 198. Generally, the requester may input a requester identification and password. A sample user interface screen as seen by the requester is shown in FIG. 8. Using its security features put in place (e.g., firewall), host system 118 verifies the access permissions associated with the requester at step 212. If the requester does not have permission to access the information at step 214, the request is denied at step 216 and the process ends at step 226. Otherwise, based upon the type of request, host system 118 searches data repository 120 for parsed reservation information and history data, extracts the relevant data at step 218 and, using an analysis engine, analyzes the data at step 220. For example, customs zone 128 may have requested expected passenger volumes (by destination) for the time period between six o'clock a.m. and ten o'clock p.m. Using passenger reservation data and history data from tables 117, 119, 153, and 155, the passenger flow system predicts the expected number of passengers traveling to foreign countries at each given hour specified. The results of the analysis are posted to a web site for passenger flow system 104 at step 222. A sample graph produced by the passenger flow system is shown in FIG. 9. This information would be particularly useful to the customs group at airport 108 since the destinations relate to foreign travel.

At step 224, it is determined whether the requester has completed the inquiry. If not, the requester is redirected to a menu screen for the user interface screen and inputs another request at step 210. Otherwise, the process ends at step 226. Passenger flow system 104 may include a billing application for charging transportation facilities such as airport 108 for these services.

As indicated above, passenger reservation information may include a variety of searchable information other than flight data. This information may be classified and stored by the passenger flow system for not only allowing retailers at airport 108 to ensure proper staffing in accordance with passenger volumes in their zone area, but also to customize their sales in accordance with the type of passengers expected to pass through. For example, two scheduled flights on a given day may comprise in-bound passengers from Japan. A retailer at airport 108 that is located near the arrival zones may plan and implement a sales promotion directed to this particular group of passengers.

Repairs and maintenance to zones such as escalator 150 can be scheduled around slow passenger flow periods by analyzing expected flows for all zones affected by escalator 150. These and other activities are contemplated using the passenger flow system.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also he embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

1. A method for predicting passenger flow at a transportation facility, comprising:
receiving a request for passenger flow information from a requester;
selecting and analyzing passenger reservation data and other transportation facility-specific data in response to said request;
providing said passenger flow information based on said data, in response to said analyzing step.

2. The method of claim 1, further comprising posting said passenger flow information on a web site.

3. The method of claim 1, further comprising assigning zones to said transportation facility-specific data according to operational groups and physical locations.

4. The method of claim 1, further comprising arranging said passenger reservation data by trip and including in said passenger reservation data a number of reservations for at least one of:
a transport class;
passenger gender;
passenger booking country; and
connecting transport information.

5. The method of claim 4, wherein the step of arranging said passenger reservation data by trip includes arranging said passenger reservation by flight number.

6. The method of claim 1, further comprising the step of parsing said passenger reservation data before the selecting and analyzing step, the parsing step including removing confidential passenger information before storing said passenger reservation data in a data repository; and the selecting step further comprising selecting said passenger reservation data from said data repository.

7. The method of claim 1, further comprising including in said passenger reservation data at least one of:
travel itinerary data including at least one of:
hotel reservation data;
booking country of travel; and
travel package data; and
car rental data.

8. The method of claim 1, further comprising including in said transportation facility-specific data past records of passenger flow activities including at least one of:
gate allocation by arrival data;
gate allocation by departure data;
actual number of passengers aboard a craft;
actual arrival times for said craft; and
actual departure times for said craft.

9. The method of claim 1, wherein said request for passenger flow information includes expected passenger volumes for a future time period, said expected passenger volumes classified by at least one of:
travel date;
travel time;
zone;
destination;
arrival;
departure;
transportation facility; and
foreign travel.

10. The method of claim 9, further comprising
classifying said expected passenger volumes by at least one of:
flight number;
passenger gender;
booking country;
flight class;
passenger age; and
nature of travel.

11. The method of claim 1, further comprising presenting said passenger flow information in graphical form.

12. The method of claim 1, further comprising billing said transportation facility in accordance with passenger flow requests received.

13. A storage medium encoded with machine-readable computer program code for predicting passenger flow at a transportation facility, said storage medium including instructions for causing a computer to implement a method, comprising:
receiving a request for passenger flow information from a requester;
selecting and analyzing passenger reservation data and other transportation facility-specific data in response to said request;
providing said passenger flow information based on said data, in response to said analyzing step.

14. The storage medium of claim 13, wherein zones are assigned to said transportation facility-specific data according to operational groups and physical locations.

15. The storage medium of claim 13, said passenger reservation data being arranged by trip and including a number of reservations for:
a transport class;
passenger gender;
passenger booking country; and
connecting transport information.

16. The storage medium of claim 13, wherein results of said analysis are posted on a web site.

17. The storage medium of claim 15, wherein said passenger reservation data arranged by trip includes arranging said passenger reservation by flight number.

18. The storage medium of claim 13, further comprising parsing said passenger reservation data before performing the selecting and analyzing step by removing confidential passenger information before storing said passenger reservation data in a data repository; wherein the selecting step includes selecting passenger reservation data from said data repository.

19. The storage medium of claim 13, wherein said passenger reservation data further comprises at least one of:
travel itinerary data including at least one of:
hotel reservation data;
booking country of travel; and
travel package data; and
car rental data.

20. The storage medium of claim 13, wherein said transportation facility-specific data comprises past records of passenger flow activities including:
gate allocation by arrival data;
gate allocation by departure data;
actual number of passengers aboard a craft;
actual arrival times for said craft; and
actual departure times for said craft.

21. The storage medium of claim 13, wherein said request for passenger flow information includes expected passenger volumes for a future time period, said expected passenger volumes classified by at least one of:
travel date;
travel time;
zone;
destination;
arrival;
departure;
transportation facility; and
foreign travel.

22. The storage medium of claim 21, wherein said expected passenger volumes are further classified by at least one of:
flight number;
passenger gender;
booking country;
flight class;
passenger age; and
nature of travel.

23. The storage medium of claim 13, wherein said passenger flow information is presented in graphical form.

24. The storage medium of claim 13, further comprising billing said transportation facility in accordance with passenger flow requests received.

25. A system for predicting passenger flow at a transportation facility, comprising:
a global distribution system;
a passenger flow system in communication with said global distribution system via a communications network; and
at least one transportation facility in communication with said passenger flow system via a communications network;
wherein said passenger flow system includes
means for receiving a request for passenger flow information from a requester;
means for selecting and analyzing passenger reservation data and other transportation facility-specific data in response to said request;
means for providing said passenger flow information based on the analysis of the passenger reservation data and the transportation facility-specific data.

26. The system of claim 25, wherein said passenger flow system includes means for_assigning zones to said at least one transportation facility-specific data according to operational groups and physical locations.

27. The system of claim 25, said passenger reservation data being arranged by trip and including a number of reservations for:
a transport class;
passenger gender;
passenger booking country; and
connecting transport information.

28. The system of claim 25, wherein results of said analysis are posted on a web site.

29. The system of claim 25, further comprising a passenger booking agent in communication with said global distribution center and said passenger flow system.

30. The system of claim 25, wherein said passenger flow system includes a billing application operable for charging said transportation facility and said passenger booking agent for executed requests for passenger flow information.

31. The system of claim 25, wherein said passenger flow system further includes a graphics application operable for providing passenger flow information in pictorial form.
